(19) United States
(12) Patent Application Publication
(10) Pub. No.: US 2022/0048515 A1
(43) Pub. Date: Feb. 17, 2022

(54) INFORMATION PROCESSING APPARATUS, INFORMATION PROCESSING METHOD AND ROAD SURFACE MARKING SYSTEM

(71) Applicant: TOYOTA JIDOSHA KABUSHIKI KAISHA, Toyota-shi (JP)

(72) Inventors: Yurika TANAKA, Yokosuka-shi (JP); Shuichi SAWADA, Nagoya-shi (JP); Shin SAKURADA, Toyota-shi (JP); Yasuhiro BABA, Kawabe-cho (JP); Shintaro MATSUTANI, Kariya-shi (JP); Tomoya MAKINO, Kariya-shi (JP)

(73) Assignee: TOYOTA JIDOSHA KABUSHIKI KAISHA, Toyota-shi (JP)

(21) Appl. No.: 17/391,337

(22) Filed: Aug. 2, 2021

(30) Foreign Application Priority Data
Aug. 11, 2020 (JP) 2020-136040

(51) Int. Cl. B60W 40/06; G06K 9/00; G01C 21/34; G01C 21/36

(52) U.S. Cl. CPC B60W 40/06; G06K 9/00798; G01C 21/3446; B60W 2420/40; B60W 2552/20; B60W 2552/53; G01C 21/3605

(57) ABSTRACT

An information processing apparatus disclosed controls a road surface marking apparatus capable of forming a desired road surface marking by changing the pattern of light emission of a plurality of light emitters provided on the surface of a road. The information processing apparatus has a controller. The controller obtains emergency information relating to the occurrence of a disaster and determines an affected area that is affected by the disaster on the basis of the emergency information. The controller changes a marking formed by a road surface marking apparatus provided on the road surface in the affected area into a specific marking that indicates the type of the disaster, an area to which people should evacuate, or an evacuation route.

### CROSS-REFERENCE TO RELATED APPLICATIONS

This application claims the benefit of Japanese Patent Application No. 2020-136040, filed on Aug. 11, 2020, which is hereby incorporated by reference herein in its entirety.

### BACKGROUND

### Technical Field

The present disclosure relates to a technology used to control road surface markings.

### Description of the Related Art

It is known in a prior art to warn users of a disaster or the like when it occurs by controlling or changing the color or brightness of light emitted from an LED light emitter provided on a illumination apparatus (see, for example, Patent Literature 1 in the citation list below).

### CITATION LIST

### Patent Literature

Patent Literature 1: Japanese Patent Application Laid-Open No. 2016-206848

### SUMMARY

An object of this disclosure is to provide a technology that enables efficient use of a road surface marking apparatus in an emergency caused by a disaster.

Disclosed herein is an information processing apparatus for controlling a road surface marking apparatus capable of forming a desired road surface marking by changing the pattern of light emission of a plurality of light emitters provided on the surface of a road. The information processing apparatus may comprise a controller including at least one processor, which is configured to execute the processing of:

obtaining emergency information relating to the occurrence of a disaster;

determining an affected area that is affected by the disaster on the basis of the emergency information; and

changing a marking formed by a road surface marking apparatus provided on the road surface in the affected area into a specific marking according to the emergency information.

Also disclosed herein is an information processing method for controlling a road surface marking apparatus capable of forming a desired road surface marking by changing the pattern of light emission of a plurality of light emitters provided on the surface of a road. The information processing method may comprise the following steps of processing executed by a computer:

obtaining emergency information relating to the occurrence of a disaster;

determining an affected area that is affected by the disaster on the basis of the emergency information; and

changing a marking formed by a road surface marking apparatus provided on the road surface in the affected area into a specific marking according to the emergency information.

Also disclosed herein is a road surface marking system comprising a road surface marking apparatus including a plurality of light emitters provided on the surface of a road and capable of forming a desired road surface marking by changing the pattern of light emission of the light emitters, and the above-described information processing apparatus.

Also disclosed herein is an information processing program that causes a computer to execute the above-described information processing method and a non-transitory storage medium in which this information processing program is stored in a computer-readable manner.

This disclosure provides a technology that enables efficient use of a road surface marking apparatus in an emergency caused by a disaster.

### BRIEF DESCRIPTION OF DRAWINGS

FIG. 1 a diagram illustrating the general configuration of a road surface marking system.

FIG. 2 is a diagram illustrating an exemplary configuration of the road surface marking system.

FIG. 3 is a diagram illustrating an exemplary arrangement of light emitters.

FIG. 4 is a block diagram illustrating an exemplary functional configuration of a server apparatus.

FIG. 5 illustrates an exemplary structure of a pattern information table.

FIG. 6 is a diagram schematically illustrating an exemplary configuration of a first marking change command.

FIG. 7 is a diagram schematically illustrating an exemplary configuration of a second marking change command.

FIG. 8 is a flow chart of a process performed by the server apparatus.

FIG. 9 is a diagram illustrating an exemplary specific marking based on the first marking change command.

FIG. 10 is a diagram illustrating an exemplary specific marking based on the first marking change command.

FIG. 11 is a diagram illustrating an exemplary road surface marking in an evacuation route.

### DESCRIPTION OF EMBODIMENTS

There are known systems that distribute emergency information issued by a public organization or the like when a disaster occurs or a possibility of the occurrence of a disaster arises. Examples of the emergency information mentioned here include emergent earthquake information, tsunami warnings, and weather and other special warnings issued by the Meteorological Agency and disaster and evacuation information issued by government offices or local public entities. Emergency information distributed by such systems is received by receivers provided in houses or buildings or portable terminals carried by users, and the receivers or the portable terminals provide the emergency information to users. However, there can be cases where details of emergency information cannot be communicated quickly and satisfactorily to the users in the area affected or expected to be affected by a disaster only by such systems. For example, there is a possibility that users being outside (of buildings) or users not carrying cellular phones cannot know details of the emergency information quickly. When evacuation from the affected area is necessary, there may be cases where users cannot clearly see destination places to which they should evacuate or evacuation routes to there.

The technology disclosed herein is characterized in that details of emergency information is communicated to users by using road surface marking apparatuses provided in the area affected or expected to be affected by a disaster. The technology disclosed herein is applied to a road surface marking system including a road surface marking apparatus and an information processing apparatus capable of controlling the road surface marking apparatus. The road surface marking apparatus mentioned here is, for example, an apparatus that can generate desired road surface markings by changing the pattern of light emitted from a plurality of light emitters provided on the surface of a road. The road surface marking apparatus may use a projector provided above the road surface to project desired markings on the road surface. The information processing apparatus is provided with a controller that controls the road surface marking apparatus, when a disaster occurs or a possibility of the occurrence of a disaster arises. When a disaster occurs or a possibility of the occurrence of a disaster arises, the controller obtains emergency information relating to the disaster. In doing so, the controller may receive emergency information distributed by a public organization or the like. When the controller receives emergency information in this way, it determines an area in which a disaster has occurred or an area in which a disaster can occur shortly. Such an area will be referred to as “affected area”. Such an affected area may be determined, for example, on the basis of the name(s) of a region(s) specified by the emergency information. In cases where the emergency information is distributed only in the affected area, the affected area may be determined on the basis of the name(s) of a region(s) in which the emergency information is distributed. After determining the affected area, the controller controls the road surface marking apparatus in the affected area to change the road surface making in the affected area into a specific marking according to the emergency information. The specific marking used here is a marking that informs users of the fact that this area is an area that is or can be affected by a disaster. This enables users to know immediately whether the area in which they are located is an area affected by a disaster only by seeing a road surface marking nearby. Especially in cases where a user is outside or where the user is not carrying a cellular phone, the user can know immediately that the area in which he or she is located is an area affected by a disaster only by seeing the road surface marking nearby. The specific marking mentioned in this disclosure is formed by light emitters, and therefore it can have high visibility to users at night. In order to call users' attention to the road surface marking, the specific marking may be caused to blink or change its color continuously.

The specific marking according to this disclosure may include a marking indicating the type of the disaster. This enables users in the affected area to know the type of the disaster that is occurring or expected to occur in the affected as well as the fact that the area in which they are located is the affected area only by seeing the road surface marking nearby.

In cases where the emergency information includes information recommending evacuation from the affected area, the controller according to this disclosure may include a marking recommending evacuation from the affected area in the specific marking. This enables users in the affected area to determine immediately whether it is necessary for them to evacuate from the area in which they are located by seeing the road surface marking nearby. This can consequently help users in the affected area to evacuate therefrom quickly.

In cases where the emergency information includes information recommending evacuation from the affected area, the controller may obtain information about a destination area that is appropriate as a destination of evacuation from the affected area. Then, the controller may include a marking indicating the destination area in the specific marking. The marking indicating the destination area mentioned here may be, for example, a marking indicating the location of the destination area or a marking showing the name of the destination area. Thus, when seeing the road surface marking nearby, users in the affected area can know an appropriate destination of evacuation as well as the fact that it is necessary for them to evacuate from the area in which they are present. Therefore, this can prevent users in the affected area from evacuating to an area that is not appropriate as a destination of evacuation.

In the case where the controller obtains information about the destination area, the controller may determine an evacuation route between the affected area and the destination area. The evacuation route between the affected area and the destination area refers to a route from each place in the affected area to the destination area exclusive of its portion included in the affected area. The controller may include a marking for guiding people to the evacuation route in the specific marking. The marking for guiding people to the evacuation route may include a marking indicating a route from each place in the affected area to the evacuation route. This enables the users in the affected area who see the road surface marking nearby to reach the evacuation route quickly and efficiently.

The controller may further execute the processing of changing the marking formed by a road surface marking apparatus provided on the evacuation route into a marking indicating the direction to the destination area. This enables users who reach the evacuation route from the affected area to evacuate to the destination area quickly by following the road surface marking on the evacuation route. In the case where the controller executes this processing, it may further execute the processing of sending a command to automotive navigation systems of vehicles located in the affected area to cause them to provide route guidance based on the evacuation route. This can guide users who evacuate from the affected area by vehicles to the destination area with improved reliability.

There may be cases where there are a plurality of routes between the affected area and the destination area. In such cases, the controller may select the evacuation route from among the plurality of route taking the type of the disaster into consideration. For example, in the case where the disaster can bring about a flood in the affected area, the controller may select the route having the highest altitude among the plurality of routes as the evacuation route. In the case where the disaster can bring about a fire in the affected area, the controller may select the route located most windward among the plurality of routes as the evacuation route. In the case where the disaster can bring about a landslide or earthflow in the affected area, the controller may select the route with the least possibility of damage by a landslide or earthflow by its geography among the plurality of routes as the evacuation route. For example, the controller may select the route with the least height difference between the road and its neighboring land or a route with no nearby rivers. In the case where the disaster is a disaster brought about by an earthquake, the controller may select the route in which the seismic intensity at the time of occurrence of the earthquake was lowest among the plurality of routes as the evacuation route. Guiding users in the affected area along the evacuation route selected as above enables the users to evacuate to the destination area safely and quickly.

In the case where the disaster to which the emergency information relates is a disaster that requires mobilization of emergency vehicles, such as fire engines or ambulances, there may be cases where emergency vehicles are stopped or parked near the place of their fire-extinguishing activities or emergency activities. In such cases, if ordinary vehicles are stopped or parked near such a place, they can be hindrance to the fire-extinguishing or emergency activities. To prevent such situations from occurring, the controller may further execute the processing of obtaining information about an expected parking place in the affected area at which an emergency vehicle is expected to be stopped or parked and changing the marking formed by the road surface marking apparatus provided at the expected parking place to a marking indicating no stopping and no parking for ordinary vehicles. This can prevent ordinary vehicles from being stopped or parked near the place where fire-extinguishing activities or emergency activities are to be performed. This can lead to improved efficiency of the fire-extinguishing activities or emergency activities.

### Embodiment

In the following, a specific embodiment of the technology disclosed herein will be described with reference to the drawings. It should be understood that the dimensions, materials, shapes, relative arrangements, and other features of the components that will be described in connection with the embodiment are not intended to limit the technical scope of this disclosure only to them, unless otherwise stated. What is described in the following as an embodiment is a case where the technology disclosed herein is applied to a road surface marking system.

(Outline of Road Surface Marking System)

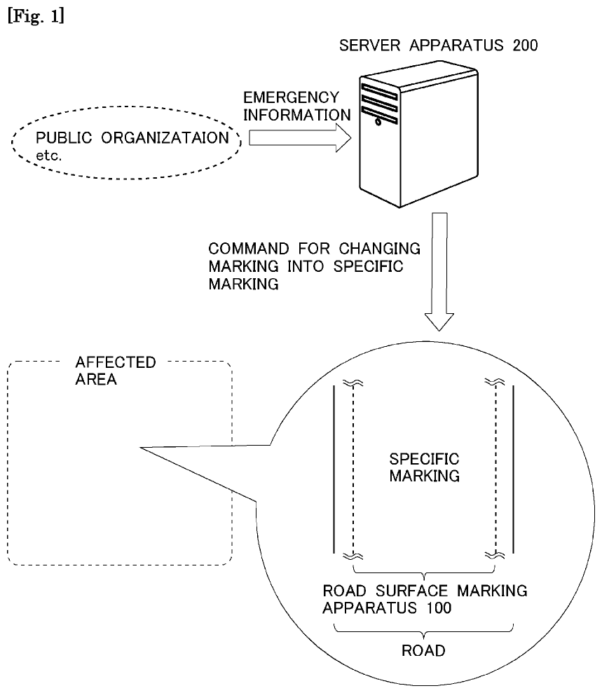

FIG. 1 is a diagram illustrating the general configuration of the road surface marking system. When emergency information relating to a disaster is distributed by a public organization or the like, the road surface marking system of this embodiment changes the road surface markings in the affected area into a marking according to the emergency information, which will be referred to as “specific marking”. Examples of the emergency information mentioned in connection with the embodiment include emergent earthquake information, tsunami warnings, and weather and other special warnings issued by the Meteorological Agency or other entity and disaster and evacuation information issued by government offices or local public entities. The road surface marking system includes road surface marking apparatuses 100 and a server apparatus 200.

The road surface marking apparatus 100 includes a plurality of light emitters provided on the road surface to form a road surface marking in the form of characters or illustrations etc. using a plurality of light emitters. The road surface marking apparatus 100 is capable of changing the road surface marking it forms by changing the light emitters 101 selected to emit light from among the plurality of light emitters 101. For example, the road surface marking apparatus 100 can change the position and/or the number of division lines that indicate lane boundaries by changing the light emitters 101 selected to emit light. The road surface marking apparatus 100 can also change a regulatory marking it forms on the road surface into another by changing the light emitters 101 selected to emit light. Moreover, the road surface marking apparatus 100 of this embodiment has the function of changing the road surface marking into a specific marking. For example, when emergency information is distributed, the road surface marking apparatus 100 changes the road surface marking in the affected area into a specific marking in response to a request from the server apparatus 200. The specific marking mentioned above is a marking that makes users aware that that area is an area affected or expected to be affected by a disaster. Details of the specific marking is determined based on a command sent from the server apparatus 200.

The server apparatus 200 is an information processing apparatus that controls the road surface marking apparatus 100. When emergency information is distributed from a public organization or the like, the server apparatus 200 firstly determines an area affected by the disaster. The server apparatus 200 may determine the affected area on the basis of the name(s) of a region(s) specified by the emergency information. In cases where the emergency information is distributed only in the affected area, the server apparatus 200 may determine the affected area on the basis of the name(s) of a region(s) in which the emergency information is distributed. The information about the affected area may be provided to the server apparatus 200 from the public organization that distributes the emergency information in addition to the emergency information.

After determining the affected area, the server apparatus 200 determines a marking (or specific marking) to be formed by each road surface marking apparatus 100 in the affected area. For example, the server apparatus 200 determines a marking indicating the type of the disaster as the specific marking. More specifically, in the case where the type or magnitude of the disaster requires evacuation from the affected area, the server apparatus 200 may include a marking recommending evacuation from the affected area in the specific marking. Determination as to whether evacuation from the affected area is necessary or not may be determined based on whether or not information recommending evacuation from the affected area is contained in the emergency information or based on information that is provided separately from the public organization or the like that distributes the emergency information. The marking recommending evacuation from the affected area may include a marking indicating a destination area and/or a marking for guiding people to an evacuation route. After determining the specific marking, the server apparatus 200 sends a command for changing each road surface marking in the affected area into the specific marking to the road surface marking apparatus 100. This command will also be referred to as “marking change command” hereinafter.

(Hardware Configuration of Road Surface Marking System)

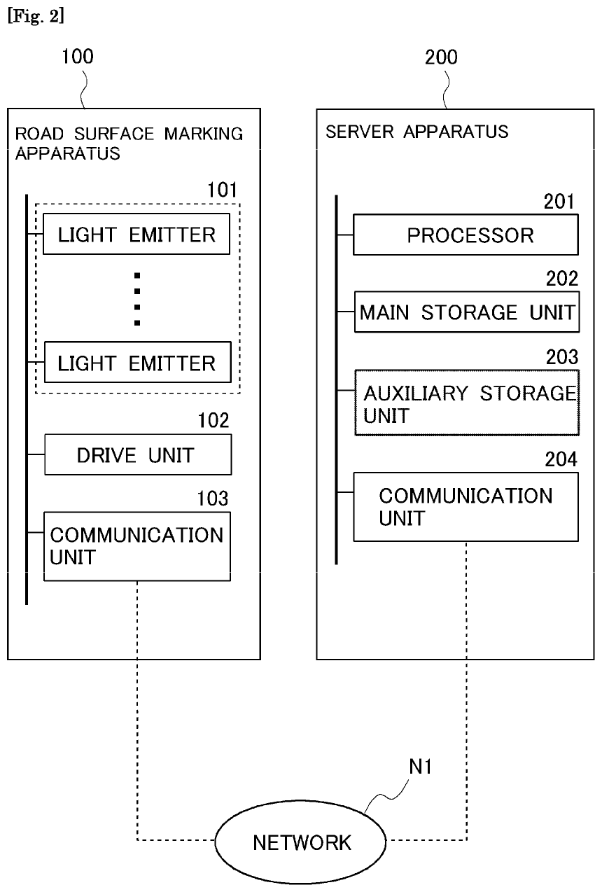

In the following, the hardware configuration of the road surface marking system will be described. FIG. 2 is a diagram illustrating the hardware configurations of the road surface marking apparatus 100 and the server apparatus 200 illustrated in FIG. 1.

The road surface marking apparatus 100 is an apparatus capable of forming a desired road surface marking on the road. The road surface marking apparatus 100 includes a plurality of light emitters 101, a driving unit 102, and a communication unit 103.

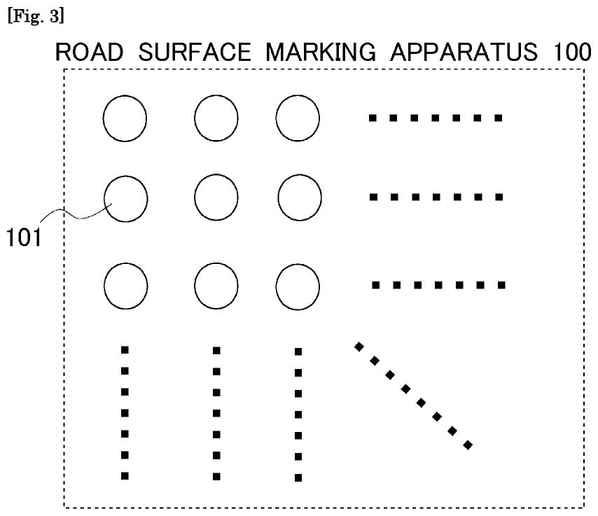

The plurality of light emitters 101 are arranged on the surface of a road in a matrix as illustrated in FIG. 3. The arrangement of the light emitters 101 is not limited to one illustrated in FIG. 3. The light emitters 101 may be arranged in any manner, so long as they can express desired characters and/or illustrations. The light emitters 101 provided on the road surface may include, for example, LEDs (Light Emitting Diodes) or optical fibers.

The driving unit 102 is a circuit that drives the plurality of light emitters 101 individually. The driving unit 102 controls the timing of light emission and the quantity of emitted light of each light emitter 101. For example, the drive unit 102 controls the timing of light emission and the quantity of emitted light of the light emitters 101 at selected positions to form a road surface marking in the form of characters and/or illustrations. The drive unit 102 can form a road surface marking including a dynamic illustration by continuously changing the light emitters 101 selected to emit light. Each light emitter 101 may include a plurality of LEDs of different colors. In that case, the drive unit 102 can change the color of the light emitted from each light emitter 101 by controlling the quantities of light emitted from the LEDs of different colors in each light emitter 101. The drive unit 102 of this embodiment controls the timing of light emission, the quantity of emitted light, and the color of emitted light of light emitters 101 that are designated to emit light in a predetermined light emission pattern to form a road surface marking. Data relating to a light emission pattern is constituted by, for example, a combination of the following kinds of data.
data 1: data designating light emitters 101 to emit light
data 2: data specifying the timing of light emission from each of the light emitters 101 to emit light
data 3: data specifying the quantity of light emitted from each of the light emitters 101 to emit light
data 4: data specifying the color of light emitted from each of the light emitters 101 to emit light

The light emission pattern data described above is stored in advance in a storage device or the like of the road surface marking apparatus 100. More specifically, the storage device or the like of the road surface marking apparatus 100 stores a plurality of sets of light emission pattern data that correspond to the types of disasters and necessity or unnecessity of evacuation etc., which will be described later. The plurality of sets of light emission pattern data include the following types of light emission patterns.
light emission pattern A: light emission pattern for forming a road surface marking that represents a lane line and a regulatory sign by a combination of characters and an illustration
light emission pattern B: light emission pattern for forming a road surface marking that represents the type of a disaster by characters and/or an illustration
light emission pattern C: light emission pattern for forming a road surface marking that represents the type of a disaster, a destination area, and the direction to an evacuation route by characters and/or an illustration

Each of the above light emission patterns B and C includes multiple types of light emission pattern data that are sorted according to the types of disasters.

The communication unit 103 is a device that connects the road surface marking apparatus 100 to a network N1. The network N1 may be, for example, a WAN (Wide Area Network), which may be a global public communication network such as the Internet, or other communication network. The communication unit 103 connects the road surface marking apparatus 100 to the server apparatus 200 through the network N1. The communication unit 103 includes a LAN (Local Area Network) interface board or a wireless communication circuit for wireless communication.

The hardware configuration of the road surface marking apparatus 100 is not limited to the above-described exemplary configuration, but some components may be eliminated, replaced by other components, or added fitly. For example, the road surface marking apparatus 100 may be constructed by embedding an LCD panel or an EL panel covered with a transparent surface protection member made of strengthened glass in the road.

The server apparatus 200 is an information processing apparatus that controls the road surface marking apparatus 100. The server apparatus 200 has a configuration as an ordinary computer. The server apparatus 200 has a processor 201, a main storage unit 202, an auxiliary storage unit 203, and a communication unit 204. The processor 201, the main storage unit 202, the auxiliary storage unit 203, and the communication unit 204 are interconnected by busses.

The processor 201 may be, for example, a CPU (Central Processing Unit) or a DSP (Digital Signal Processor). The processor 201 controls the server apparatus 200 and executes computations of various information processing.

The main storage unit 202 may include, for example, a RAM (Random Access Memory), a ROM (Read Only Memory) and/or the like. The auxiliary storage unit 203 may include, for example, an EPROM (Erasable Programmable ROM) or a hard disk drive (HDD). The auxiliary storage unit 203 may include a removable medium, in other words, a portable recording medium. Examples of the removable medium include an USB (Universal Serial Bus) memory and disc recording media, such as a CD (Compact Disc) and a DVD (Digital Versatile Disc). The auxiliary storage unit 203 stores various programs, various data, and various tables, which can be written into and read out from the auxiliary storage unit 203 when necessary. The auxiliary storage unit 203 may store an operating system (OS) also. All or a portion of the aforementioned information or data stored in the auxiliary storage unit 203 may be stored in the main storage unit 202 instead. Likewise, information or data stored in the main storage unit 202 may be stored in the auxiliary storage unit 203 instead.

The communication unit 204 is a device used to connect the server apparatus 200 to the network N1. The communication unit 204 connects the server apparatus 200 to the road surface marking apparatus 100 via the network N1. The communication unit 204 includes, for example, a LAN (Local Area Network) interface board or a wireless communication circuit for wireless communication. The road surface marking apparatus 100 and the server apparatus 200 may be connected electrically without using the network N1.

The hardware configuration of the server apparatus 200 is not limited to the above-described exemplary configuration illustrated in FIG. 2, but some components may be eliminated, replaced by other components, or added fitly. Various processing executed by the server apparatus 200 may be executed either by hardware or software.

(Functional Configuration of Server Apparatus)

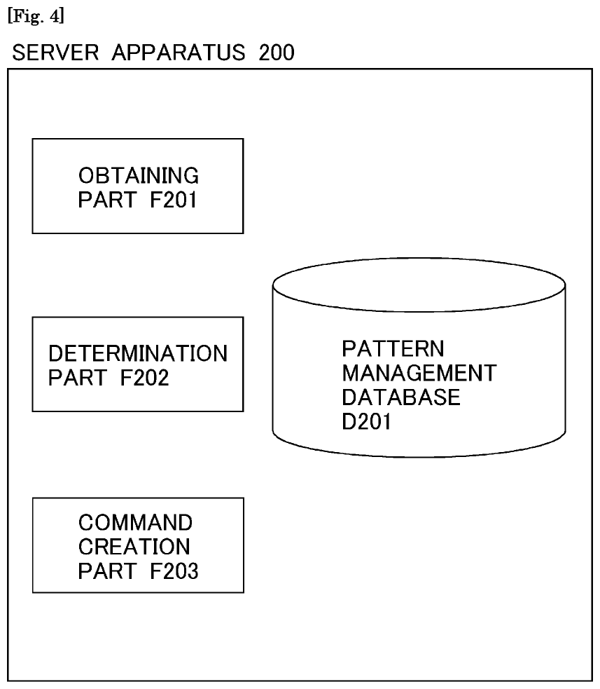

The functional configuration of the server apparatus 200 will now be described with reference to FIG. 4. The server apparatus 200 includes, as functional components, an obtaining part F201, a determination part F202, a command creation part F203, and a pattern management database D201.

The server apparatus 200 implements the obtaining part F201, the determination part F202, and the command creation part F203 by executing a program stored in the main storage unit 202 or the auxiliary storage unit 203 by the processor. One or some of the obtaining part F201, the determination part F202, and the command creation part F203 may be implemented partly or entirely by a hardware circuit(s). One or some of the obtaining part F201, the determination part F202, and the command creation part F203 may be implemented by another computer connected to the network N1, or a portion of the processing of the obtaining part F201, the determination part F202, and the command creation part F203 may be executed by another computer connected to the network N1. For example, the processing of the obtaining part F201, the processing of the determination part F202, and the processing of the command creation part F203 may be executed by different computers.

The pattern management database D201 is constructed by a database management system program (DBMS program) executed by the processor 201. More specifically, the DBMS program manages data stored in the auxiliary storage unit 203 to construct the pattern management database D201. The pattern management database D201 constructed in this way is, for example, a relational database.

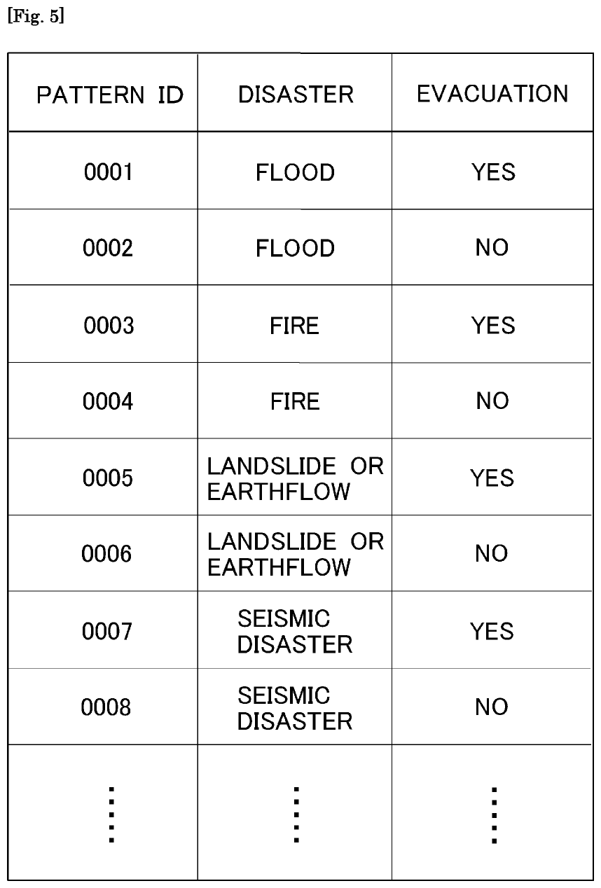

The pattern management database D201 stores information relating to light emission patterns of the light emitters 101 employed in forming specific markings. In the pattern management database D201, types of disasters and the light emission patterns are linked. An exemplary structure of the information stored in the pattern management database D201 will be described with reference to FIG. 5. FIG. 5 illustrates an exemplary table structure of the information stored in the pattern management database D201. It should be understood that the structure of the table stored in the pattern management database D201 (which will also be referred to as “pattern information table” hereinafter) is not limited to that illustrated in FIG. 5, but some fields may be added, changed, or removed fitly.

The pattern information table illustrated in FIG. 5 has the fields of pattern ID, disaster, and evacuation. What is stored in the pattern ID field is information (or pattern ID) for identifying each of the light emission patterns included in the aforementioned light emission patterns B and C. What is stored in the disaster field is information indicating the type of disaster for which each light emission pattern is suitable. For example, in the case of light emission patterns suitable for a flood, the information “flood” is stored in the disaster fields linked with them. In the case of light emission patterns suitable for a fire, the information “fire” is stored in the disaster fields linked with them. In the case of light emission patterns suitable for a landslide or earthflow, the information “landslide or earthflow” is stored in the disaster fields linked with them. In the case of light emission patterns suitable for a seismic disaster, the information “seismic disaster” is stored in the disaster fields linked with them. What is stored in the evacuation field is information indicating whether or not each light emission pattern is suitable for evacuation guidance. For example, in the case of light emission patterns suitable for evacuation guidance, the information “yes” is stored in the evacuation field linked with them. In the case of light emission patterns not suitable for evacuation guidance, the information “no” is stored in the evacuation field linked with them.

The obtaining part F201 obtains emergency information relating to a disaster. For example, when the communication unit 204 of the server apparatus 200 receives emergency information distributed by a public organization or the like, the emergency information is passed from the communication unit 204 to the obtaining part F201, so that the obtaining part F201 obtains the emergency information. The emergency information obtained by the obtaining part F201 is passed from the obtaining part F201 to the determination part F202.

The determination part F202 determines an area affected by the disaster to which the emergency information relates. In cases where the name(s) of a region(s) affected by the disaster is specified by the emergency information, the determination part F202 determines the affected area on the basis of the specified name(s) of the region(s). In cases where the emergency information is distributed only in the affected area, the determination part F202 determines the affected area on the basis of, for example, the name(s) of the region(s) in which the emergency information is distributed. Information about the name(s) of the region(s) in which the emergency information is distributed may be provided to the server apparatus 200 separately from the emergency information by the public organization or the like that distributes the emergency information. After the area affected by the disaster is determined in this way, information about the affected area determined and the emergency information are passed from the determination part F202 to the command creation part F203.

The command creation part F203 creates a marking change command on the basis of the information received from the determination part F202. The marking change command is a command to cause the road surface marking apparatus 100 to change the road surface marking in the affected area into a specific marking. In the process of creating the marking change command, the command creation part F203 firstly determines the type of the disaster to which the emergency information relates. For example, in the case where the emergency information is information reporting the occurrence or the possible occurrence of a flood, the command creation part F203 determines that the disaster to which the emergency information relates is a flood. In the case where the emergency information is information reporting the occurrence or the possible occurrence of a fire, the command creation part F203 determines that the disaster to which the emergency information relates is a fire. In the case where the emergency information is information reporting the occurrence or the possible occurrence of a landslide or earthflow, the command creation part F203 determines that the disaster to which the emergency information relates is a landslide or earthflow. In the case where the emergency information is information reporting the occurrence or the possible occurrence of a seismic disaster, the command creation part F203 determines that the disaster to which the emergency information relates is a seismic disaster.

After determining the type of the disaster to which the emergency information relates, the command creation part F203 determines whether or not immediate evacuation from the affected area is necessary. For example, if the emergency information includes information recommending evacuation from the affected area, the command creation part F203 determines that immediate evacuation from the affected area is necessary. On the other hand, if the emergency information does not include information recommending evacuation from the affected area, the command creation part F203 determines that immediate evacuation from the affected area is not necessary.

After determining the type of the disaster and the necessity or unnecessity of evacuation, the command creation part F203 accesses the pattern management database D201 using the type of the disaster and the necessity or unnecessity of evacuation as arguments to determine a light emission pattern that matches the arguments. For example, the command creation part F203 firstly selects pattern information tables in which information that matches the type of disaster determined above is stored in their disaster field from among the pattern information tables stored in the pattern management database D201. Then, the command creation part F203 finds a pattern information table among the selected pattern information tables in which information that matches the necessity or unnecessity of evacuation determined above is stored in its evacuation field. For example, in the case where the type of the disaster determined is a flood and it is determined that evacuation is necessary, the command creation part F203 finds a pattern information table in which the information “flood” is stored in its disaster field and the information “yes” is stored in its evacuation field. In the cases where the type of the disaster determined is a flood and it is determined that evacuation is not necessary, the command creation part F203 finds a pattern information table in which the information “flood” is stored in its disaster field and the information “no” is stored in its evacuation field. Then, the command creation part F203 retrieves the information (or pattern ID) stored in the pattern ID field of the pattern information table found as above.

In the case where it is determined that immediate evacuation from the affected area is necessary, the command creation part F203 further executes the processing of determining a destination area and an evacuation route. If the emergency information includes information about a destination area, the command creation part F203 may determine the destination area on the basis of this information. Information about the destination area may be provided to the server apparatus 200 by an external service. After determining the destination area in this way, the command creation part F203 determines an evacuation route between the affected area and the destination area. The evacuation route between the affected area and the destination area refers to a route from each place in the affected area to the destination area exclusive of its portion included in the affected area. If there is a recommended evacuation route determined in advance, this recommended evacuation route may be employed. If there is no particular recommended evacuation route, the command creation part F203 may determine an evacuation route. In doing so, if there is only one route between the affected area and the destination area, the command creation part F203 selects this route as the evacuation route. If there are a plurality of routes between the affected area and the destination area, the command creation part F203 may select one evacuation route from among the plurality of routes on the basis of the type of the disaster determined as above. For example, if the type of the disaster determined as above is a flood, the command creation part F203 may select the route having the highest altitude among the plurality of routes as the evacuation route. If the type of the disaster determined as above is a fire, the command creation part F203 may select the route located most windward among the plurality of routes as the evacuation route. If the type of the disaster determined as above is a landslide or earthflow, the command creation part F203 may select the route with the least possibility of damage by a landslide or earthflow among the plurality of routes as the evacuation route. For example, the command creation part F203 may select the route with the least height difference between the road and its neighboring land or a route with no nearby rivers. If the type of the disaster determined as above is a seismic disaster, the command creation part F203 may select the route in which the seismic intensity at the time of occurrence of the earthquake was lowest among the plurality of routes as the evacuation route.

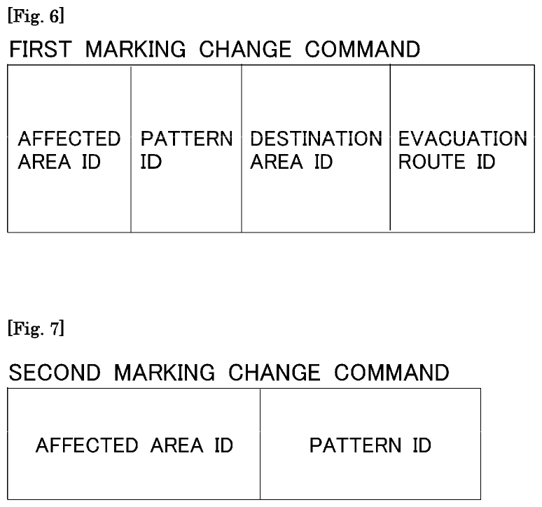

After retrieving and obtaining various information as above, the command creation part F203 creates a marking change command on the basis of the obtained information. An exemplary configuration of the marking change command created in the system of this embodiment will be described next with reference to FIGS. 6 and 7. FIG. 6 is a diagram schematically illustrating the configuration of a marking change command created by the command creation part F203 in the case where immediate evacuation from the affected area is necessary. FIG. 7 is a diagram schematically illustrating the configuration of a marking change command created by the command creation part F203 in the case where immediate evacuation from the affected area is not necessary.

In the case where immediate evacuation from the affected area is necessary, the command creation part F203 creates a marking change command containing an affected area ID, a pattern ID, a destination area ID, and an evacuation route ID as illustrated in FIG. 6. This type of marking change command will also be referred to as “first marking change command” hereinafter. The affected area ID is the ID of the affected area. The area ID is information assigned to each area in advance to identify it. The affected area ID may be information for identifying each light emitter 101 provided in the affected area. The pattern ID is the pattern ID of the light emission pattern determined as above. This pattern ID is the pattern ID that identifies the light emission pattern selected from among the light emission patterns C according to the type of the disaster determined as above. The destination area ID is the area ID of the destination area determined as above. The destination area ID may be replaced by information indicating the location or the name of the destination area. The evacuation route ID is the route ID of the evacuation route determined as above. The route ID is information assigned to each route to identify it. In the case where immediate evacuation from the affected area is not necessary, the command creation part F203 creates a marking change command containing the affected area ID and the pattern ID but not containing the destination area ID nor the evacuation route ID as illustrated in FIG. 7. This type of marking change command will be referred to as “second marking change command” hereinafter. The pattern ID contained in the second marking change command is the pattern ID that identifies the light emission pattern selected from among the light emission patterns B according to the type of the disaster determined as above. The first or second marking change command (which will also be simply referred to as “marking change command” hereinafter) created in this way is sent from the command creation part F203 to each road surface marking apparatus 100 through the communication unit 204.

The command creation part F203 may create the first marking change command irrespective of whether the emergency information contains information recommending evacuation from the affected area or not.

(Process Performed by Server Apparatus)

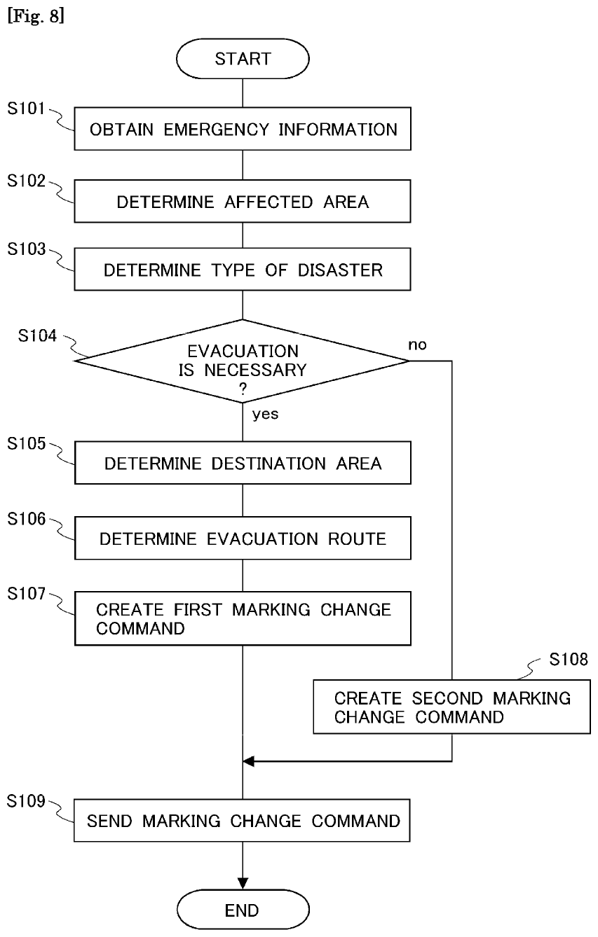

A process performed by the server apparatus 200 will be described with reference to FIG. 8. FIG. 8 is a flow chart of the process performed by the server apparatus 200, which is triggered by reception of emergency information relating to a disaster.

In the process according to the flow chart of FIG. 8, when the communication unit 204 of the server apparatus 200 receives emergency information, the emergency information is passed to the obtaining part F201. Thus, the obtaining part F201 obtains the emergency information (step S101). The emergency information obtained by the obtaining part F201 is passed to the determination part F202.

The determination part F202 determines an area affected by the disaster (or affected area) on the basis of the emergency information (step S102). If the name(s) of the region(s) affected by the disaster is specified in the emergency information, the determination part F202 determines the affected area on the basis of the name(s) of the region(s). In the case where the emergency information is distributed only in the affected area, the determination part F202 determines the affected area on the basis of the name(s) of the region(s) in which the emergency information is distributed. Information about the affected area determined by the determination part F202 (e.g. the area ID of the affected area) is passed from the determination part F202 to the command creation part F203 together with the emergency information.

The command creation part F203 determines the type of the disaster to which the emergency information relates on the basis of the emergency information (step S103). Then, the command generation part F203 determines whether or not immediate evacuation from the affected area is necessary on the basis of the emergency information (step S104). For example, if the emergency information contains information recommending evacuation from the affected area, the command creation part F203 determines that immediate evacuation from the affected area is necessary (an affirmative answer in step S104). On the other hand, if the emergency information does not contain information recommending evacuation from the affected area, the command creation part F203 determines that immediate evacuation from the affected area is not necessary (a negative answer in step S104).

If step S104 is answered in the affirmative, the command creation part F203 determines a destination area to which people should evacuate from the affected area (step S105). Information about the destination area used in this step may be information contained in the emergency information or information provided by an external service.

After determining the destination area, the command creation part F203 determines an evacuation route between the affected area and the destination area (step S106). If there is a recommended evacuation route predetermined beforehand, the command creation part F203 selects the recommended evacuation route as the evacuation route of this time. Alternatively, the command creation part F203 may determine the evacuation route of this time according to the type of the disaster determined in step S103 as described above.

After determining the destination area and the evacuation route, the command creation part F203 creates the first marking change command (step S107). Specifically, the command creation part F203 firstly accesses the pattern management database D201 on the basis of the type of the disaster determined in step S103 to select the pattern information tables that match the disaster. More specifically, the command creation part F203 firstly selects the pattern information tables in which information that matches the type of the disaster determined in step S103 is stored in their disaster fields from among the pattern information tables stored in the pattern management database D201. Then, the command creation part F203 finds the pattern information table in which the information “yes” is stored in its evacuation field from among the pattern information tables selected as above. Then, the command creation part F203 retrieves the information (or pattern ID) stored in the pattern ID field of the pattern information table found as above. Then, the command creation part F203 creates the first marking change command as illustrated in FIG. 6 on the basis of the retrieved pattern ID. The affected area ID contained in the first marking change command created in this way is the area ID of the affected area passed from the determination part F202. The destination area ID contained in this first marking change command is the area ID of the destination area determined in step S105. The evacuation route ID contained in this first marking change command is the route ID of the evacuation route determined in step S106.

If step S104 is answered in the negative, the command creation part F203 creates the second marking change command (step S108). Specifically, the command creation part F203 firstly accesses the pattern management database D201 on the basis of the type of the disaster determined in step S103 to select the pattern information tables in which information that matches the type of the disaster is stored in their disaster fields. Then, the command creation part F203 finds the pattern information table in which the information “no” is stored in its evacuation field from among the pattern information tables selected as above. Then, the command creation part F203 retrieves the information (or pattern ID) stored in the pattern ID field of the pattern information table found as above. Then, the command creation part F203 creates the second marking change command as illustrated in FIG. 7 on the basis of the retrieved pattern ID and the area ID of the affected area passed from the determination part F202.

The first marking change command created in step S107 or the second marking change command created in step S108 is sent from the command creation part F203 to the road surface marking apparatus 100 through the communication unit 204 (step S109).

When the communication unit 103 of the road surface marking apparatus 100 receives the first or second marking change command, the command is passed to the drive unit 102. The drive unit 102 changes the road surface marking in the affected area into the specific marking according to the first or second marking change command. In doing so, the drive unit 102 accesses the storage unit or the like using the pattern ID contained in the first or second marking change command as an argument to retrieve the light emission pattern data corresponding to this pattern ID. Then, the drive unit 102 drives the light emitters 101 in the affected area according to the retrieved light emission pattern data to form the specific marking on the road surface in the affected area.

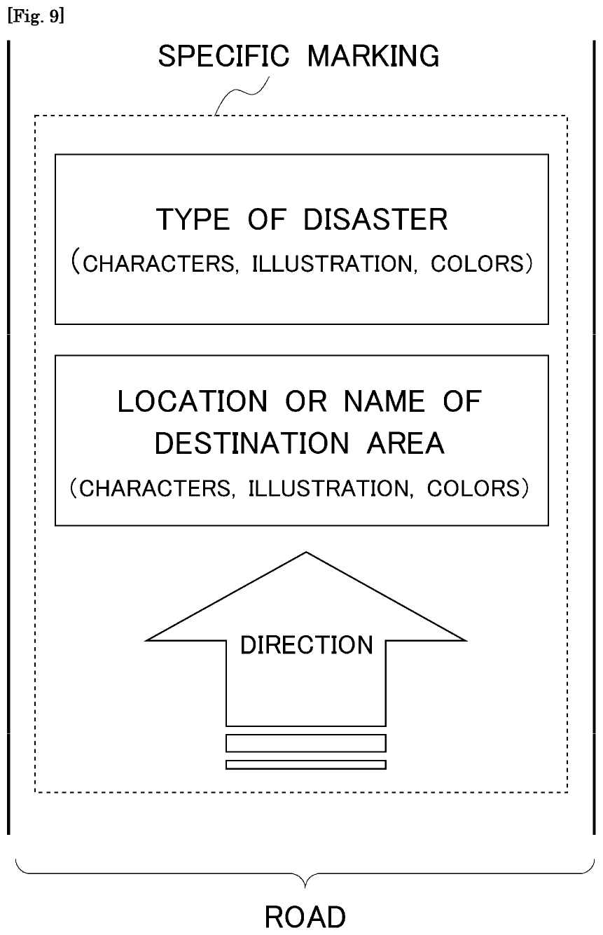

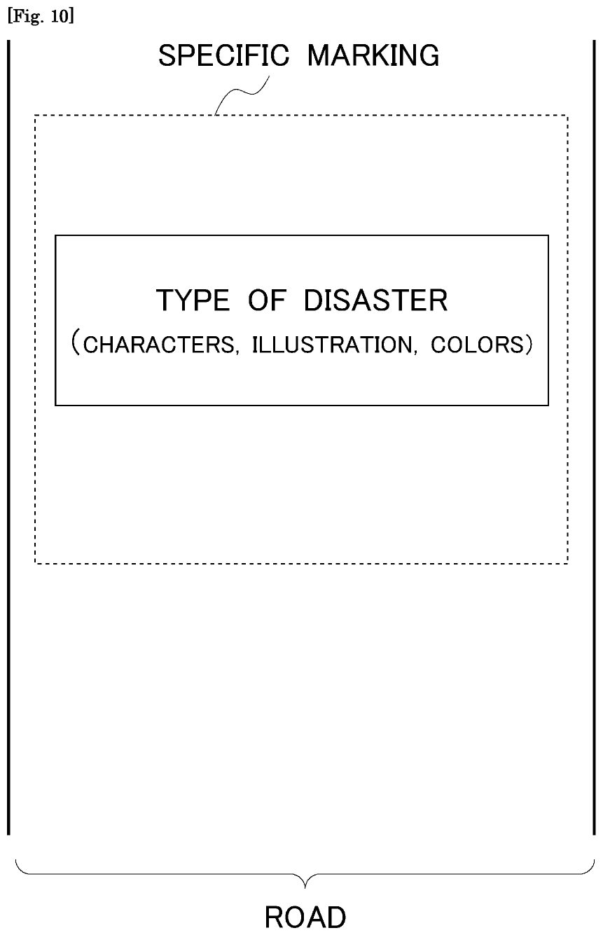

In the case where the marking change command sent from the server apparatus 200 is the first marking change command (illustrated in FIG. 6), a specific marking is formed by a light emission pattern selected according to the type of the disaster occurring or expected to occur in the affected area from among the aforementioned light emission patterns C. This specific marking includes the following markings as illustrated in FIG. 9.
road surface marking 1: a road surface marking that indicates the type of the disaster by characters, an illustration, or colors etc.
road surface marking 2: a road surface marking that indicates the location or the name of the destination area by characters or an illustration etc.
road surface marking 3: a road surface marking that indicates the direction from each place in the affected area to the evacuation route by an illustration etc.

The road surface marking that indicates the direction from each place in the affected area to the evacuation route (i.e. road surface marking 3) includes an illustration or the like that indicates the direction toward the nearest evacuation route from that place and the indicated direction varies among the locations at which the road surface markings are provided. In forming such a road surface marking, the drive unit 102 may turn on the light emitters 101 sequentially in the direction from each place to the evacuation route to form a dynamic road surface marking.

In the case where the marking change command sent from the server apparatus 200 is the second marking change command (illustrated in FIG. 7), a specific marking is formed by a light emission pattern selected according to the type of the disaster occurring or expected to occur in the affected area from among the aforementioned light emission patterns B. This specific marking includes a road surface marking that indicates the type of the disaster by characters, an illustration, or colors etc.

The process according to the flow chart of FIG. 8 enables users to know immediately whether the area in which they are located is an area affected by a disaster only by seeing a road surface marking nearby. Especially, even in cases where a user is outside or where the user is not carrying a cellular phone, he or she can know immediately that the area in which he or she is located is an area affected by a disaster only by seeing a road surface marking nearby. Since the specific marking mentioned in this disclosure is formed by light emitters, it can have high visibility to users at night. Users in the affected area can also know the type of the disaster and whether or not evacuation is necessary only by seeing a road surface marking nearby. In the case where evacuation from the affected area is necessary, users in the affected area can know the destination area and the direction to the evacuation route only by seeing a road surface marking nearby. This can prevent users in the affected area from evacuating to areas that are not destination areas or failing to reach an evacuation route quickly. Therefore, this process can let users in the affected area evacuate to the destination area quickly and efficiently.

### <First Modification>

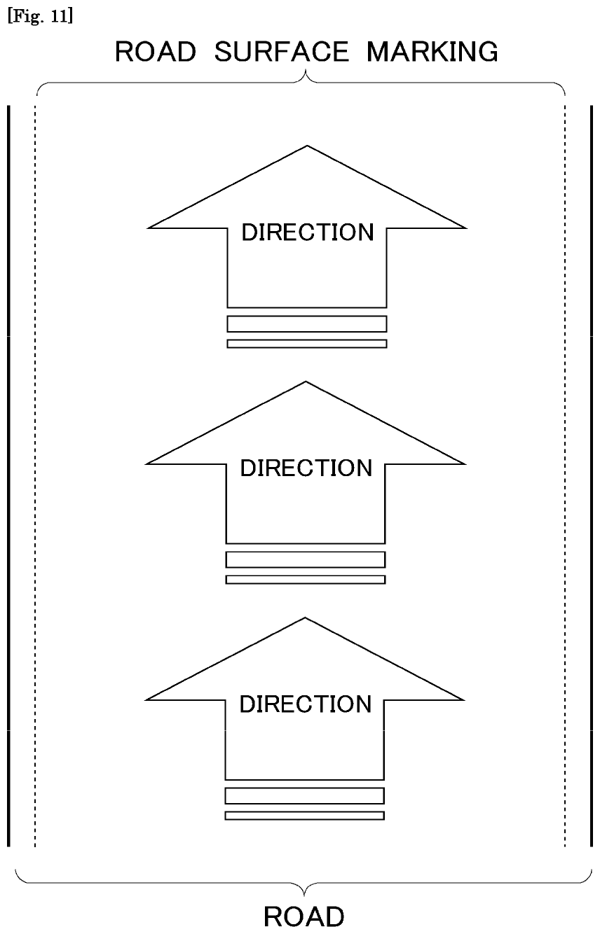

When emergency information relating to a disaster is distributed, the road surface marking system according to the above embodiment changes road markings in the affected area into specific markings. The system may further change road surface markings in the evacuation route. For example, the road surface marking system may change road surface markings in the evacuation route to markings indicating the direction from the affected area to the destination area as illustrated in FIG. 11. This enables users who reaches the evacuation route from the affected area to evacuate quickly to the destination area by following the road surface markings in the evacuation route.

### <Second Modification>

In the case where the disaster to which the emergency information relates is a disaster that requires mobilization of emergency vehicles (e.g. fire engines or ambulances), such as a fire, landslide, or earthflow, the emergency vehicles may be stopped or parked near the place of their fire-extinguishing activities or emergency activities.

In such cases, the command creation part F203 of the server apparatus 200 may change road surface markings in roads in the affected area where emergency vehicles may possibly be stopped or parked into markings indicating no stopping and no parking for ordinary vehicles. This can prevent ordinary vehicles from being stopped or parked near the place where fire-extinguishing activities or emergency activities are to be performed. This can lead to improved efficiency of the fire-extinguishing activities or emergency activities.

### <Others>

The above embodiment and modification have been described only by way of example. Modifications can be made to them without departing from the essence of this disclosure. The processes that have been described in the above descriptions of the embodiment and the modifications may be employed in any combination so long as it is technically feasible to do so. For example, features of the above-described embodiment and the first and second modifications may be employed in any feasible combination. One, some, or all of the processes that have been described as processes performed by one apparatus may be performed by a plurality of apparatuses in a distributed manner. One, some, or all of the processes that have been described as processes performed by different apparatuses may be performed by a single apparatus. The hardware configuration employed to implement various functions in a computer system may be modified flexibly.

The technology disclosed herein can be carried out by supplying a computer program(s) that implements the functions described in the above description of the embodiment to a computer to cause one or more processors of the computer to read and execute the program(s). Such a computer program(s) may be supplied to the computer by a computer-readable, non-transitory storage medium that can be connected to a system bus of the computer, or through a network. The computer-readable, non-transitory storage medium refers to a recording medium that can store information, such as data and programs, electrically, magnetically, optically, mechanically, or chemically in such a way as to allow the computer or the like to read the stored information. Examples of such a recording medium include any type of disc media including a magnetic disc, such as a floppy disc (registered trademark) and a hard disk drive (HDD), and an optical disc, such as a CD-ROM, a DVD and a Blu-ray disc. The recording medium may be other storage media, such as a read-only memory (ROM), a random access memory (RAM), an EPROM, an EEPROM, a magnetic card, a flash memory, an optical card, and a solid state drive (SSD).

What is claimed is:

1. An information processing apparatus for controlling a road surface marking apparatus capable of forming a desired road surface marking by changing the pattern of light emission of a plurality of light emitters provided on the surface of a road, comprising a controller including at least one processor, the controller being configured to execute the processing of:
obtaining emergency information relating to the occurrence of a disaster;
determining an affected area that is affected by the disaster on the basis of the emergency information; and
changing a marking formed by a road surface marking apparatus provided on the road surface in the affected area into a specific marking according to the emergency information.

2. An information processing apparatus according to claim 1, wherein the controller causes the road surface marking apparatus to form a marking that indicates the type of the disaster as the specific marking.

3. An information processing apparatus according to claim 2, wherein if the emergency information contains information recommending evacuation from the affected area, the controller includes a marking recommending evacuation from the affected area in the specific marking.

4. An information processing apparatus according to claim 3, wherein the controller is configured to further execute the processing of:
obtaining information about a destination area that is appropriate as a destination of evacuation from the affected area; and
including a marking indicating the destination area in the specific marking.

5. An information processing apparatus according to claim 4, wherein the controller further executes the processing of:
determining an evacuation route between the affected area and the destination area; and
including a marking for guiding people to the evacuation route in the specific marking.

6. An information processing apparatus according to claim 5, wherein the marking for guiding people to the evacuation route includes a marking indicating the direction from each place in the affected area to the evacuation route.

7. An information processing apparatus according to claim 5, wherein the controller further executes the processing of changing the marking formed by a road surface marking apparatus provided in the evacuation route to a marking indicating the direction to the destination area.

8. An information processing apparatus according to claim 5, wherein if there is a plurality of routes between the affected area and the destination area, the controller selects the evacuation route from among the plurality of routes on the basis of the type of the disaster.

9. An information processing apparatus according to claim 8, wherein in the case where the disaster can bring about a flood in the affected area, the controller selects the route having the highest altitude among the plurality of routes as the evacuation route.

10. An information processing apparatus according to claim 8, wherein in the case where the disaster can bring about a fire in the affected area, the controller selects the route located most windward among the plurality of routes as the evacuation route.

11. An information processing apparatus according to claim 8, wherein in the case where the disaster can bring about a landslide or earthflow, the controller selects the route with the least expected possibility of damage by a landslide or earthflow among the plurality of routes as the evacuation route.

12. An information processing apparatus according to claim 8, wherein in the case where the disaster is a disaster brought about by an earthquake, the controller may select the route in which the seismic intensity at the time of occurrence of the earthquake was lowest among the plurality of routes as the evacuation route.

13. An information processing method for controlling a road surface marking apparatus capable of forming a desired road surface marking by changing the pattern of light emission of a plurality of light emitters provided on the surface of a road, comprising the following steps of processing executed by a computer:
the first step of obtaining emergency information relating to the occurrence of a disaster;
the second step of determining an affected area that is affected by the disaster on the basis of the emergency information; and
the third step of changing a marking formed by a road surface marking apparatus provided on the road surface in the affected area into a specific marking according to the emergency information.

14. An information processing method according to claim 13, wherein in the third step, the computer causes the road surface marking apparatus to form a marking that indicates the type of the disaster as the specific marking.

15. An information processing method according to claim 14, wherein if the emergency information contains information recommending evacuation from the affected area, a marking recommending evacuation from the affected area is included in the specific marking in the third step.

16. An information processing method according to claim 15, wherein the third step further comprising the steps of:
obtaining information about a destination area that is appropriate as a destination of evacuation from the affected area; and
including a marking indicating the destination area in the specific marking.

17. An information processing method according to claim 16, wherein the third step further comprising the steps of:
determining an evacuation route between the affected area and the destination area; and
including a marking for guiding people to the evacuation route in the specific marking.

18. An information processing method according to claim 17, wherein the marking for guiding people to the evacuation route includes a marking indicating the direction from each place in the affected area to the evacuation route.

19. An information processing method according to claim 17, wherein the third step further comprising the steps of changing the marking formed by a road surface marking apparatus provided in the evacuation route to a marking indicating the direction to the destination area.

20. A road surface marking system comprising:
a road surface marking apparatus including a plurality of light emitters provided on the surface of a road and capable of forming a desired road surface marking by changing the pattern of light emission of the light emitters; and
an information processing apparatus configured to control the road surface marking apparatus,
wherein the information processing apparatus includes a controller including at least one processor, the controller being configured to execute the processing of:
obtaining emergency information relating to the occurrence of a disaster;
determining an affected area that is affected by the disaster on the basis of the emergency information; and
changing a marking formed by a road surface marking apparatus provided on the road surface in the affected area into a specific marking according to the emergency information.
